(19) United States
(12) Patent Application Publication
(10) Pub. No.: US 2003/0163325 A1
(43) Pub. Date: Aug. 28, 2003

(54) Electrical household appliance and methods for testing and for initializing a voice operating unit therein

(76) Inventor: Jens Maase, Regensburg (DE)

Correspondence Address: LERNER AND GREENBERG, P.A., POST OFFICE BOX 2480, HOLLYWOOD, FL, 33022-2480, US

(21) Appl. No.: 10/375,535

(22) Filed: Feb. 27, 2003

(30) Foreign Application Priority Data
Feb. 27, 2002 (DE) 102 08 466.1

(51) Int. Cl. G10L 21/00

(52) U.S. Cl. 704/275

(57) ABSTRACT

An electrical household appliance, in particular, a ventilator hood, includes a voice operating unit having a microphone and a voice recognition unit disposed downstream of the latter. The voice operating unit is characterized by a data memory in which voice reference data stored as electronic data are present. The voice operating unit can be calibrated using the evaluation result based upon a comparison between voice data picked up by the microphone and the voice reference data. Also provided are methods for testing a voice operating unit and for initializing a voice operating unit in the appliance.

### BACKGROUND OF THE INVENTION

1. Field of the Invention

The invention relates to an electrical household appliance, in particular, a ventilator hood, with a voice operating unit having a microphone and a voice recognition unit disposed downstream of the latter and methods for testing and for initializing a voice operating unit therein.

International Publication WO 01/59763 A1 discloses an electrical appliance with a voice input unit, and a method for voice input. The prior art appliance has a voice input unit and a voice processing unit that derives required control signals from spoken input commands to control the functions of the appliance. It is already provided, in this appliance, to undertake a correction of interference signals during the voice input. Correction is achieved by virtue of the fact that an operational status detection unit is provided that detects the operational status of the household appliance or other noise sources, and reports to the voice processing unit. The voice processing unit undertakes an interference noise correction only if a noise source is switched on. The operational status of at least one noise source that interferes with the voice input is interrogated during the voice input for controlling an electrical appliance, and the voice processing unit undertakes an interference noise correction when the noise source is switched on. The known method leads to an improvement in the voice recognition in all cases in which the voice signal is not loaded at all by interference noises.

### SUMMARY OF THE INVENTION

It is accordingly an object of the invention to provide an electrical household appliance and methods for testing and for initializing a voice operating unit therein that overcome the hereinafore-mentioned disadvantages of the heretofore-known devices and methods of this general type and that improves an electrical household appliance by raising the quality of the voice recognition.

With the foregoing and other objects in view, in an electrical household appliance, there is provided, in accordance with the invention, a voice-activation unit including a voice operating unit having a microphone for picking up voice data and outputting a voice data signal in a voice signal data direction, a voice recognition unit connected to the microphone and disposed downstream of the microphone in the voice signal data direction, and a data memory connected to the voice recognition unit and storing voice reference data therein as electronic data, the voice operating unit being programmed to compare the voice data picked up by the microphone with the voice reference data and provide a comparison evaluation result and self-calibrate based upon the comparison evaluation result. In particular, the appliance is a ventilator hood.

According to the invention, the voice operating unit includes a data memory with voice reference data stored therein as electronic data, and the voice operating unit can be calibrated using the evaluation result based upon a comparison between voice data picked up by the microphone and the voice reference data.

The aim of the testing of the acoustic signals that the microphone or another signal transducer picks up, or that reach a voice recognition unit within the electric circuit of the voice recognition unit on an electric path, is to compensate signal differences by a comparison with reference data. The reference data are either stored by the manufacturer in a data memory assigned to the voice operating unit, or they are obtained later during use at a customer.

The voice operating system is dependent on various influencing factors when recording and evaluating the acoustic signals. The signal path is subject to strongly fluctuating influencing variables. These variables change, on one hand, by virtue of the fact that the spatial configuration of the household appliance inside a room is changed, or that the acoustics of the entire room in which the household appliance is set up are modified by a change inside the room. This happens, for example, because new furniture is introduced into the room, or because furniture is rearranged inside the room. Other influencing variables are, for example, the aging of the microphone, the aging of electric and/or electronic components of the voice operating unit, or the soiling of the acoustic input system, which influence the voice recognition. These influences are taken into account according to the invention by virtue of the fact that there are stored in the data memory reference data with which the respective voice data picked up by the microphone are compared in order, thereby, to readjust or to calibrate the microphone, an electronic circuit associated with the microphone, for example, electric filters, or the voice recognition unit itself or an electronic circuit associated therewith.

In accordance with another feature of the invention, the voice reference data, which are present as electronic data in the memory, are fed to a loudspeaker that uses the electronic data to generate acoustic signals that are, then, picked up by the microphone. The test signals generated by the loudspeaker are, then, compared with voice data currently being picked up by the microphone, in order to carry out a calibration. The test tones emitted by the loudspeaker or the sound generator are picked up after passing the entire signal path and being appropriately converted thereby, evaluated, and compared with the voice reference data.

In accordance with a further feature of the invention, there is provided a loudspeaker connected to the voice operating unit, the loudspeaker generating the voice reference data as test signals from electronic data evaluated in the voice operating unit.

In accordance with an added feature of the invention, the voice operating unit is programmed to supply test signals to the loudspeaker and, thereby, cause the loudspeaker to emit output test signals and to generate the voice reference data based upon signals received by the microphone from the output test signals.

In accordance with an additional feature of the invention, the voice operating unit is a self-learning system in which the voice reference data are learned during a learning phase. This has the advantage that the voice operating unit takes account of the type of intonation and the mode of speaking of an individual selected person or a circle of a specific number of selected persons, in order to take account in a fashion adapted thereto of a change due to aging or other influences.

The voice operating unit, preferably, has a microcontroller that controls the voice recognition unit and the microphone. The microcontroller passes control signals to the microphone and the voice recognition unit when these are to be recalibrated in each case.

The microcontroller, preferably, has a comparator in which voice data transmitted by the microphone or the voice recognition unit are compared with the voice reference data, an output signal is generated, and the microcontroller is programmed to adjust at least one of the voice recognition unit and the microphone based upon the output signal generated by the comparator.

In accordance with yet another feature of the invention, the microcontroller is programmed to compare the voice data picked up by the microphone or the voice recognition unit with the voice reference data and generate an output signal and to adjust at least one of the voice recognition unit and the microphone based upon the output signal generated by the comparator.

The household appliance, preferably, also has display measures in which the functional state of the voice operating unit is displayed. It is possible, in such a case, to display whether or not, after it is first started up, the voice operating unit runs through a learning process to obtain voice reference data. It is further possible to display whether the regular operation obtains, in the case of which the voice operating unit uses voice inputs undertaken by a user in order to set, control, or change the mode of operation of the household appliance, or whether the voice operating unit carries out a new calibration operation that has become necessary because changes have taken place in the room or because the voice operating unit has experienced soiling or passed through an aging process. It is, likewise, possible to display when the voice operating unit can no longer undertake a calibration because specific limit values specified at the manufacturer's for the voice operating unit are undershot such that customer service needs to be called. It is possible to use both optical and acoustic display measures. For the case in which the voice operating unit has a loudspeaker, the loudspeaker passes acoustic signals to the operator, in particular, spoken words, as information, for example, “Please call customer service”.

With the objects of the invention in view, there is also provided a method for testing a voice operating unit in a household appliance, including the steps of providing the voice-activation unit according to the present invention and comparing the voice reference data of the data memory with the voice data picked up by the microphone.

With the objects of the invention in view, there is also provided a method for testing a voice operating unit in a household appliance, including the steps of providing a voice operating unit having a microphone for picking up voice data and outputting a voice data signal in a voice signal data direction, a voice recognition unit connected to the microphone and disposed downstream of the microphone in the voice signal data direction, and a data memory connected to the voice recognition unit and storing voice reference data therein as electronic data, comparing, with the voice operating unit, the voice data picked up by the microphone with the voice reference data and providing a comparison evaluation result, and self-calibrating based upon the comparison evaluation result.

With the objects of the invention in view, there is also provided a method for testing a voice operating unit in the household appliance, in particular, in a ventilator hood, including the steps of providing a voice-activation unit according to the present invention and comparing voice reference data of the data memory with voice data picked up by the microphone.

With the objects of the invention in view, there is also provided a method for testing a voice operating unit in a ventilator hood, including the steps of providing a voice operating unit having a microphone for picking up voice data and outputting a voice data signal in a voice signal data direction, a voice recognition unit connected to the microphone and disposed downstream of the microphone in the voice signal data direction, and a data memory connected to the voice recognition unit and storing voice reference data therein as electronic data, comparing, with the voice operating unit, the voice data picked up by the microphone with the voice reference data and providing a comparison evaluation result, and self-calibrating based upon the comparison evaluation result.

The invention also relates to a method for initializing a voice operating unit, the first step being for the loudspeaker to generate acoustic signals, electronic signals being obtained therefrom by the microphone and the voice recognition unit and being compared with the voice reference data on which the acoustic signals of the loudspeaker are based, and the microphone and/or the voice recognition unit being adjusted based upon the comparison.

With the objects of the invention in view, there is also provided a method for initializing a voice operating unit, including the steps of providing a voice-activation unit according to the present invention, generating with the loudspeaker acoustic signals from the voice reference data of the data memory, obtaining electronic signals therefrom with the microphone and the voice recognition unit, comparing the electronic signals with the voice reference data, and adjusting at least one of the microphone and the voice recognition unit based upon the comparison.

In accordance with yet a further mode of the invention, there are provided the steps of generating the voice reference data as acoustic signals with the loudspeaker, obtaining electronic signals from the loudspeaker with the microphone and the voice recognition unit, and comparing the electronic signals with the voice reference data.

In accordance with yet an added mode of the invention, there is provided the step of producing displays reproducing, on the household appliance, a state of the voice operating unit by comparing the voice data with the voice reference data.

In accordance with yet an additional mode of the invention, there is provided the step of producing displays reproducing, on the household appliance, a state of the voice operating unit based upon the comparison of the voice data with the voice reference data.

In accordance with again another mode of the invention, there are provided the steps of defining first limit parameters corresponding to a no longer acceptable quality of a voice detection and recalibrating the voice operating unit upon overshooting of the first limit parameters.

In accordance with again a further mode of the invention, there are provided the steps of defining second limit parameters corresponding to a defect or servicing condition in which proper functioning of the voice operating unit cannot be restored even by recalibration and displaying the defect or servicing condition upon overshooting the second limit parameters.

In accordance with again an added mode of the invention, there are provided the steps of defining first limit parameters corresponding to a no longer acceptable quality of a voice detection, storing the first limit parameters in the memory, and, after comparing the electronic signals with the voice reference data, self-recalibrating the voice operating unit upon overshooting of the first limit parameters.

In accordance with again an additional mode of the invention, there are provided the steps of defining second limit parameters corresponding to a defect or servicing condition in which proper functioning of the voice operating unit cannot be restored even by recalibration and after comparing the electronic signals with the voice reference data, displaying the defect or servicing condition upon overshooting the second limit parameters.

In accordance with a concomitant mode of the invention, there is provided the step of displaying an initialization operation to a user at least one of optically and acoustically with a display unit.

Other features that are considered as characteristic for the invention are set forth in the appended claims.

Although the invention is illustrated and described herein as embodied in an electrical household appliance and methods for testing and for initializing a voice operating unit therein, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, perspective view of a ventilator hood in conjunction with a cooking surface according to the invention;

FIG. 2 is a block and schematic circuit diagram of a voice operating unit according to the invention; and

FIG. 3 is a flowchart of a logic sequence of the voice operating unit according to the invention.

### DESCRIPTION OF THE PREFERRED EMBODIMENTS

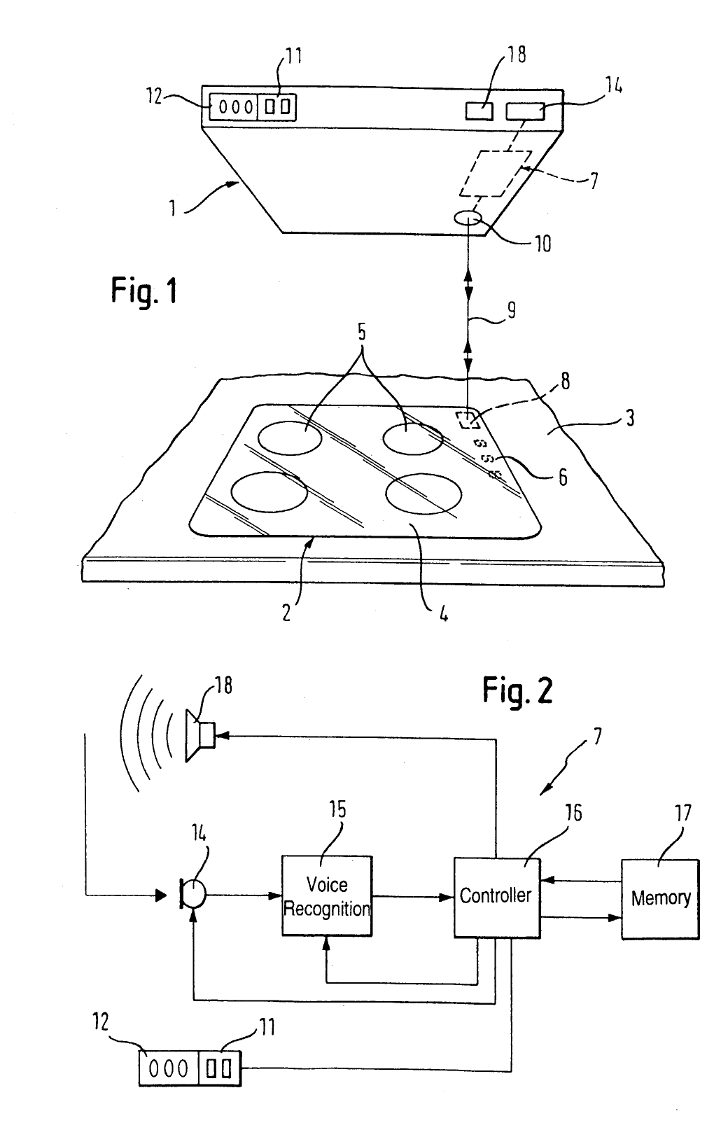

Referring now to the figures of the drawings in detail and first, particularly to FIG. 1 thereof, there is shown a ventilator hood 1 disposed above a cooking surface 2. The cooking surface 2 is mounted in a cutout of an operating plate 3. The cooking surface 2 includes a cooking surface plate 4 that is made, for example, from glass ceramic, and on which various cooking zones 5 are marked. Depending on the inputs through an operating and display unit 6 of the cooking surface 2, cooking vessels that are placed on the cooking zones 5 can be heated by heating elements that are disposed underneath the cooking surface plate 4, through a control unit. The operating and display unit 6 is present as an additional function relating to a voice operating unit 7 through which all the operating functions both of the cooking surface 2 and of the ventilator hood 1 can be carried out by voice input. Communication between the ventilator hood 1 and the cooking surface 2 is ensured by a transceiver unit 8 that is disposed in the region of the cooking surface plate 4 and that communicates with an associated transceiver unit 10 of the ventilator hood 1 through a wireless connection 9 or a wire-bound connection. The ventilator hood 1 is also fitted with an operating unit 11 and a display unit 12. Functions of the ventilator hood 1 can be input or changed by hand through the operating unit 11.

The voice operating unit 7 diagrammatically illustrated in FIG. 2 includes a microphone 14 for picking up speech from the room in which the ventilator hood 1 and the cooking surface 2 are disposed. The voice signals picked up by the microphone 14 are converted into electronic signals and fed to a voice recognition unit 15. Various parameters, which include, for example, the loudness level, the frequency response of the system, the signal transit times, etc. are obtained in the voice recognition unit 15 from the voice signals fed therein.

Preprocessing of the voice data, therefore, takes place in the voice recognition unit 15. The voice data are compared by a microcontroller 16 with voice reference data stored in a nonvolatile memory 17 and that have been read out from the memory 17 for such a purpose. The microcontroller 16, therefore, includes a comparator by which the comparison function is executed. By using the comparison of the data, the microcontroller 16 carries out adjustment operations on the microphone 14 and/or the voice recognition unit 15 or on electronic circuits respectively assigned to them, in order to optimize the pickup capacity of the microphone 14 and the voice recognition unit 15 in accordance with the voice reference data once stored.

The voice reference data are either stored at the manufacturer in the memory 17, or they are generated by a loudspeaker 18 with the aid of test signal data likewise stored in the memory 17. The test signals propagate in the room and take account in so doing of the specific acoustics of the room, and are, subsequently, transmitted to the microcontroller 16 through the microphone 14 and the voice recognition unit 15, thereby passing the entire signal path. The picked-up signals, thus converted again into electronic form, can be compared with the test signals from the memory 17, which are present there in electronic form, in the microcontroller 16, and the latter, then, if necessary, undertakes appropriate adjustments at the microphone 14 and/or the voice recognition unit 15. The display unit 12 can display the various operating steps of the voice operating unit.

The test operation to be controlled by the microcontroller 16 is carried out for the first time preferably when the ventilator hood 1 and the cooking surface 2 are being set up in a room, and the test operation is initialized, for example, when an operator uses the operating unit 11 to make a keyed input. For selection purposes, either recourse is made to reference data stored in the memory 17, which have already been provided at the manufacturer, or the operator is included in the test operation by being prompted to output voice signals that are, then, stored in the memory 17 such that they are available for later test operations of the voice operating unit 7. Such a test operation is always instituted when limit parameters that lead to impairment of the performance of the voice operating unit 7 are overshot. The entire system, then, has to be recalibrated, which is performed in the way described above. If the parameters overshoot a further limit value, which denotes an even lower measure of voice recognition, this is a sign of impending failure of the voice operating unit 7, which is seen in poorer voice recognition. Consequently, corresponding signaling devices inform the uses of the servicing case, either by optical signals at the display unit 12, or by acoustic signals of the loudspeaker 18.

It, therefore, emerges that a substantial deviation in the data picked up during a test operation points to a changed overall system, which renders recalibration necessary. Recalibration is, then, instituted automatically. In such a case, for example, an audible tone sequence advises the user of the recalibration. Even when no data similar to the reference data can be obtained after the recalibration, such a state is stored as a fault, and various forms of fault reporting and signaling inform the user and/or customer services which defects have occurred on the voice recognition unit 7. In the case of safety-relevant applications, the voice operating unit 7 is switched off entirely, in order to prevent erroneous inputs through the voice operating unit 7. It, thus, emerges that a multiplicity of influencing factors, for example, a defect at the loudspeaker or sound generator, a changed spatial characteristic, soiling of the microphone grille, aging of the microphone, or a fault in the electronic input branch of the voice operating unit 7, lead through the inventive method for testing the voice operating unit 7 to changes in voice detection that can all be detected by the comparison function implemented in the microcontroller 16, in order to draw consequences therefrom for the operation of the household appliance. Such changes in the system, in particular, the aging or changing of the signal path, as well as the aging or soiling of the system, cannot be detected quantitatively in prior art systems. In such a prior art system, this could have the effect of calling in customer services even when there is, in reality, no servicing case. Such a disadvantageous condition would lead to additional costs that can be avoided by the invention.

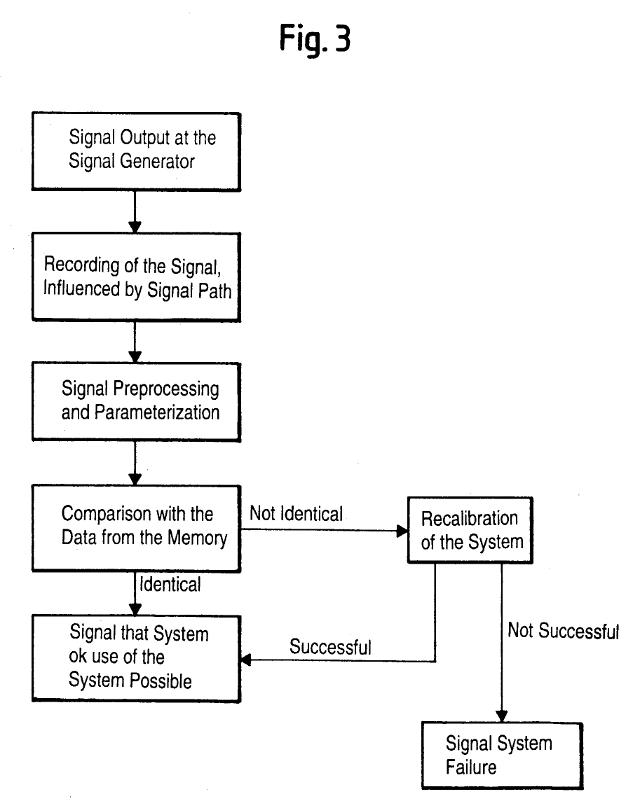

The logic sequence in the voice operating unit 7 can be illustrated with the aid of the block diagram of FIG. 3. First, a signal is output at a signal generator, that is to say, the loudspeaker 18. Its signal is influenced by the signal path and picked up by the microphone 14. Signal preprocessing and parameterization are undertaken inside the voice recognition unit 15. The picked-up data are, thus, compared in the microcontroller 16 with the data from the memory 17. If they are identical, the display unit 12 generates a signal that informs the operator that the system is ok and may be used. If the comparison shows that the data are not identical, the system is recalibrated. If the recalibration is successful, in turn, the same display results as when the data are identical, specifically, that the system is operating acceptably. However, if the recalibration of the system was not successful, the display unit 12 signals the failure of the system.

I claim:

1. In an electrical household appliance, a voice-activation unit comprising:
a voice operating unit having:
a microphone for picking up voice data and outputting a voice data signal in a voice signal data direction;
a voice recognition unit connected to said microphone and disposed downstream of said microphone in said voice signal data direction; and
a data memory connected to said voice recognition unit and storing voice reference data therein as electronic data;
said voice operating unit being programmed to:
compare the voice data picked up by said microphone with said voice reference data and provide a comparison evaluation result; and
self-calibrate based upon said comparison evaluation result.

2. The voice-activation unit according to claim 1, further comprising a loudspeaker connected to said voice operating unit, said loudspeaker generating said voice reference data as test signals from electronic data evaluated in said voice operating unit.

3. The voice-activation unit according to claim 1, further comprising:
a loudspeaker connected to said voice operating unit; and
said voice operating unit being programmed:
to supply test signals to said loudspeaker and, thereby, cause said loudspeaker to emit output test signals; and
to generate said voice reference data based upon signals received by said microphone from said output test signals.

4. The voice-activation unit according to claim 1, wherein said voice operating unit is a self-learning system by which said voice reference data is learned during a learning phase.

5. The voice-activation unit according to claim 1, wherein said voice operating unit has a microcontroller for controlling said microphone and said voice recognition unit.

6. The voice-activation unit according to claim 5, wherein:
said microcontroller has a comparator comparing the voice data picked up by said microphone or said voice recognition unit with said voice reference data and generating an output signal; and
said microcontroller is programmed to adjust at least one of said voice recognition unit and said microphone based upon said output signal generated by said comparator.

7. The voice-activation unit according to claim 5, wherein said microcontroller is programmed to:
compare the voice data picked up by said microphone or said voice recognition unit with said voice reference data and generate an output signal; and
adjust at least one of said voice recognition unit and said microphone based upon said output signal generated by said comparator.

8. The voice-activation unit according to claim 7, wherein:
said voice operating unit has at least one functional state; and
a display indicates to a user said at least one functional state of said voice operating unit.

9. The voice-activation unit according to claim 7, further comprising a means for displaying a functional state of said voice operating unit.

10. In a ventilator hood, a voice-activation unit comprising:
a voice operating unit having:
a microphone for picking up voice data and outputting a voice data signal in a voice signal data direction;
a voice recognition unit connected to said microphone and disposed downstream of said microphone in said voice signal data direction; and
a data memory connected to said voice recognition unit and storing voice reference data therein as electronic data;
said voice operating unit being programmed to:
compare the voice data picked up by said microphone with said voice reference data and provide a comparison evaluation result; and
self-calibrate based upon said comparison evaluation result.

11. A method for testing a voice operating unit in a household appliance, which comprises:
providing the voice-activation unit according to claim 1; and
comparing the voice reference data of the data memory with the voice data picked up by the microphone.

12. The method according to claim 11, which further comprises:
generating the voice reference data as acoustic signals with the loudspeaker;
obtaining electronic signals from the loudspeaker with the microphone and the voice recognition unit; and
comparing the electronic signals with the voice reference data.

13. The method according to claim 11, which further comprises producing displays reproducing, on the household appliance, a state of the voice operating unit by comparing the voice data with the voice reference data.

14. The method according to claim 11, which further comprises producing displays reproducing, on the household appliance, a state of the voice operating unit based upon the comparison of the voice data with the voice reference data.

15. The method according to claim 11, which further comprises:
defining first limit parameters corresponding to a no longer acceptable quality of a voice detection; and
recalibrating the voice operating unit upon overshooting of the first limit parameters.

16. The method according to claim 15, which further comprises:
defining second limit parameters corresponding to a defect or servicing condition in which proper functioning of the voice operating unit cannot be restored even by recalibration; and
displaying the defect or servicing condition upon overshooting the second limit parameters.

17. The method according to claim 12, which further comprises:
defining first limit parameters corresponding to a no longer acceptable quality of a voice detection;
storing the first limit parameters in the memory;
after comparing the electronic signals with the voice reference data, self-recalibrating the voice operating unit upon overshooting of the first limit parameters.

18. The method according to claim 17, which further comprises:
defining second limit parameters corresponding to a defect or servicing condition in which proper functioning of the voice operating unit cannot be restored even by recalibration; and
after comparing the electronic signals with the voice reference data, displaying the defect or servicing condition upon overshooting the second limit parameters.

19. A method for testing a voice operating unit in a household appliance, which comprises:
providing a voice operating unit having:
a microphone for picking up voice data and outputting a voice data signal in a voice signal data direction;
a voice recognition unit connected to the microphone and disposed downstream of the microphone in the voice signal data direction; and
a data memory connected to the voice recognition unit and storing voice reference data therein as electronic data;
comparing, with the voice operating unit, the voice data picked up by the microphone with the voice reference data and providing a comparison evaluation result; and
self-calibrating based upon the comparison evaluation result.

20. A method for testing a voice operating unit in a ventilator hood, which comprises:
providing a voice-activation unit according to claim 1; and
comparing voice reference data of the data memory with voice data picked up by the microphone.

21. A method for testing a voice operating unit in a ventilator hood, which comprises:
providing a voice operating unit having:
a microphone for picking up voice data and outputting a voice data signal in a voice signal data direction;
a voice recognition unit connected to the microphone and disposed downstream of the microphone in the voice signal data direction; and
a data memory connected to the voice recognition unit and storing voice reference data therein as electronic data;
comparing, with the voice operating unit, the voice data picked up by the microphone with the voice reference data and providing a comparison evaluation result; and
self-calibrating based upon the comparison evaluation result.

22. A method for initializing a voice operating unit, which comprises:
providing a voice-activation unit according to claim 2;
generating with the loudspeaker acoustic signals from the voice reference data of the data memory;
obtaining electronic signals therefrom with the microphone and the voice recognition unit;
comparing the electronic signals with the voice reference data; and
adjusting at least one of the microphone and the voice recognition unit based upon the comparison.

23. The method according to claim 22, which further comprises displaying an initialization operation to a user at least one of optically and acoustically with a display unit.
